(19) United States
(12) Patent Application Publication
(10) Pub. No.: US 2026/0263956 A1
(43) Pub. Date: Sep. 10, 2026

(54) PROCESSING METHOD AND APPARATUS FOR SOCIAL INTERACTIONS WITH A ROBOT

(71) Applicant: NATIONAL CHENGCHI UNIVERSITY, Taipei City (TW)

(72) Inventors: Chao-Ling CHEN, Taipei City (TW); Chen-Jun LIU, Taipei City (TW); Yun-Han LEE, Taipei City (TW); Yi-Chieh SUNG, Taipei City (TW)

(73) Assignee: NATIONAL CHENGCHI UNIVERSITY, Taipei City (TW)

(21) Appl. No.: 19/556,220

(22) Filed: Mar. 4, 2026

(30) Foreign Application Priority Data
Mar. 4, 2025 (TW) 114107953

(51) Int. Cl. A63H 11/00; G06V 20/56; G10L 15/08; G10L 15/22

(52) U.S. Cl. CPC A63H 11/00; G06V 20/56; G10L 15/08; G10L 15/22; G10L 2015/088; G10L 2015/223

(57) ABSTRACT

A processing method for social interactions with a robot is applicable to an interactive robot and includes: converting a sound into a sound signal when the sound in an activity area of the interactive robot is detected; performing a speech recognition on the sound signal to generate a speech string, and determining whether the speech string matches a first command keyword; when the speech string matches the first command keyword, controlling a camera circuit to capture an image, and selecting a new model from a plurality of candidate character models stored in a storage based on the image; and updating a retrieval database stored in the storage by utilizing the new model, so as to display the new model on a display of the interactive robot.

### CROSS-REFERENCE TO RELATED APPLICATIONS

This application claims priority to and the benefit of Taiwanese Patent Application No. TW 114107953, filed on Mar. 4, 2025, disclosures of which are incorporated herein by reference in its entirety.

### BACKGROUND OF THE DISCLOSURE

### Technical Field

The present disclosure relates to a technology for robot interactions, and more particularly to a processing method and apparatus for social interactions with a robot.

### Description of Related Art

In recent years, robots have been widely applied in households, such as robotic vacuum cleaners, assistive robots, and robotic pets. However, typical household robots generally possess only simple and single functions, making it difficult for them to engage in complex social interactions with users. Moreover, feelings of loneliness are common among individuals living alone and elderly people, with the latter being particularly affected, which may even impact their psychological well-being. Therefore, how to utilize typical household robots to engage in social interactions with the users so as to improve the psychological states of the users is a problem that those skilled in the art are eager to solve.

### SUMMARY OF THE INVENTION

The main objective of the present disclosure is to provide a processing method and apparatus for social interactions with a robot, which may enhance the social interactions of a typical household interactive robot and improve the psychological state of a user through such social interactions.

To achieve the above objectives, the present disclosure provides a processing method for social interactions with a robot, applicable to an interactive robot, including: step a) converting a sound into a sound signal via a sound receiving circuit when the sound in an activity area of the interactive robot is detected; step b) performing a speech recognition on the sound signal via a processor to generate a speech string, and determining whether the speech string matches a first command keyword; step c) when the speech string matches the first command keyword, controlling a camera circuit via the processor to capture an image, and selecting a new model from a plurality of candidate character models stored in a storage based on the image; and step d) updating a retrieval database stored in the storage using the new model via the processor, so as to display the new model on a display of the interactive robot.

To achieve the above objectives, the present disclosure provides a processing apparatus for robot interactions, disposed in an interactive robot, including: a camera circuit configured to capture an image; a sound receiving circuit configured to convert a sound into a sound signal when the sound in an activity area of the interactive robot is detected; a storage configured to store a retrieval database, a plurality of candidate character models, and a plurality of commands; and a processor connected to the camera circuit, the sound receiving circuit, and the storage, and accessing the commands to perform the following actions: action a) performing a speech recognition on the sound signal to generate a speech string, and determining whether the speech string matches a first command keyword; action b) when the speech string matches the first command keyword, controlling the camera circuit to capture the image, and selecting a new model from the candidate character models based on the image; and action c) updating the retrieval database by utilizing the new model, so as to display the new model on a display of the interactive robot.

Compared with the related art, the present disclosure combines the speech recognition with visual and auditory interactions of the interactive robot, and enables the interactive robot to have dialogues with the user, as well as visual interactions with virtual characters, thereby enhancing the social interactions of the interactive robot and improving the psychological state of the user through such social interactions.

### BRIEF DESCRIPTION OF THE DRAWINGS

FIG. 1A illustrates a block diagram of a processing apparatus for social interactions with a robot according to some embodiments of the present disclosure.

FIG. 1B illustrates a schematic diagram of an interactive robot in an activity area according to some embodiments of the present disclosure.

FIG. 2 illustrates a flowchart of a processing method for social interactions with a robot according to some embodiments of the present disclosure.

FIG. 3 illustrates a schematic diagram of selected candidate character models according to some embodiments of the present disclosure.

FIG. 4 illustrates a flowchart of a processing method for social interactions with a robot further including a plurality of steps according to some embodiments of the present disclosure.

FIG. 5 illustrates a schematic diagram of a plurality of character groups according to some embodiments of the present disclosure.

FIG. 6 illustrates a flowchart of a processing method for social interactions with a robot further including a plurality of steps according to other embodiments of the present disclosure.

### DETAILED DESCRIPTION

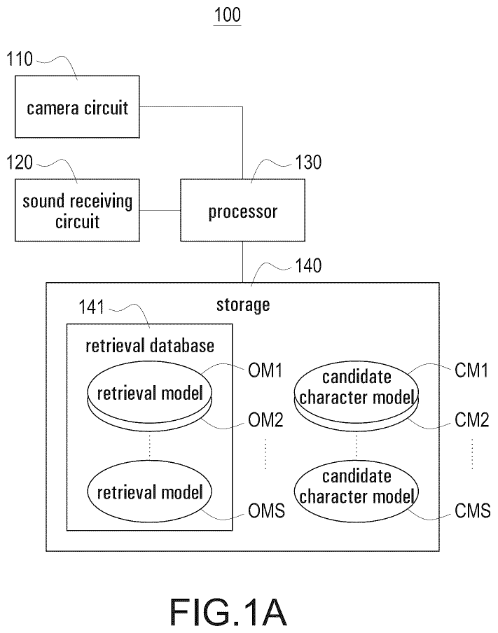

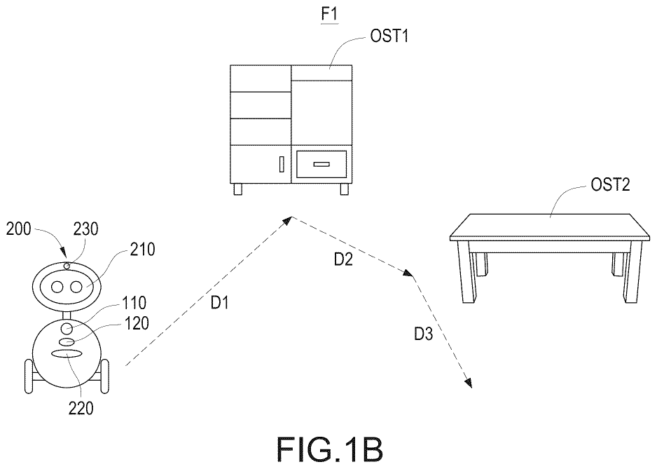

Referring to FIG. 1A, FIG. 1A illustrates a block diagram of a processing apparatus 100 for social interactions with a robot in some embodiments of the present disclosure. As shown in FIG. 1A, in the present embodiment, the processing apparatus 100 includes a camera circuit 110, a sound receiving circuit 120, a processor 130, and a storage 140. The processor 130 is connected to the camera circuit 110, the sound receiving circuit 120, and the storage 140.

In this embodiment, the processing apparatus 100 is disposed on the interactive robot to perform various controls or operations on the interactive robot. In some embodiments, the interactive robot may move within a specific activity area and is capable of performing the social interactions described in the following paragraphs with a user. In other words, the interactive robot is designed to interact naturally with the user within a specific activity area and to respond according to the user's actions as described in the following paragraphs. In some embodiments, the interactive robot may be implemented as any type of home robot having sound and image interaction capabilities (for example, a doll-type robot or a humanoid social-assistive robot). In some embodiments, the activity area may be implemented as any type of place for the user's activities or rest (for example, a living room or a bedroom). In some embodiments, the user may be an ordinary person, an elderly person, or a person with limited mobility within the activity area.

In this embodiment, the camera circuit 110 is configured to capture images. In some embodiments, the camera circuit 110 may be disposed at any location on the interactive robot from which the activity area may be captured (for example, a location on a surface of the interactive robot facing the moving direction of the interactive robot). In some embodiments, the camera circuit 110 may be implemented by any image capturing circuit (for example, an optical camera circuit, an infrared camera circuit, a three-dimensional camera circuit, or the like).

In this embodiment, the sound receiving circuit 120 is configured to convert a sound into a sound signal when the sound in the activity area of the interactive robot is detected. In some embodiments, the sound receiving circuit 120 may be disposed at any location on the interactive robot from which the sound in the activity area may be detected (for example, a location on a surface of the interactive robot facing the moving direction of the interactive robot). In some embodiments, the sound receiving circuit 120 may be implemented by any microphone having a sound capturing function (for example, a capacitive microphone, a piezoelectric microphone, an optical microphone, or the like).

In this embodiment, the storage 140 stores a retrieval database 141 and a plurality of commands. In some embodiments, the retrieval database 141 is configured to store retrieval models OM1-OMS (for example, virtual two-dimensional or three-dimensional image models) acquired by the user, wherein S is equal to the number of virtual two-dimensional or three-dimensional image models acquired by the user. In some embodiments, each command may be implemented by any software or firmware. In this embodiment, the processor 130 is configured to access these commands to perform a processing method for social interactions with a robot as described in the following paragraphs. In some embodiments, the processor 130 is further configured to perform various controls on various circuits or components of the interactive robot (for example, a display, a broadcasting circuit, a steering mechanism, or the like).

In some embodiments, the storage 140 further stores a plurality of candidate character models CM1-CMT. The candidate character models CM1-CMT are all virtual two-dimensional or three-dimensional image models that the user may acquire when interacting with the interactive robot. In other words, when interacting with the interactive robot, the user may acquire several candidate character models from the candidate character models CM1-CMT, and these candidate character models are stored in the retrieval database 141 as retrieval models OM1-OMS. In some embodiments, the candidate character models CM1-CMT are pre-designed by a designer and stored in the storage 140.

The following illustrates a scenario in which the processor 130 controls the interactive robot 200. Referring also to FIG. 1B, FIG. 1B is a schematic diagram of the interactive robot 200 in an activity area F1 in some embodiments of the present disclosure. As shown in FIG. 1B, in this embodiment, the processing apparatus 100 is disposed on the interactive robot 200, which includes a display 210, a sonar sensor 220, and a sound playback circuit 230. The display 210 is configured to display images for visual interactions with the user. The sonar sensor 220 is configured to detect a distance to obstacles in front in the moving direction of the interactive robot 200 to prevent collisions with the obstacles. The sound playback circuit 230 is configured to play sounds for auditory interaction with the user.

In some embodiments, the sonar sensor 220 is disposed on a surface of the interactive robot 200 facing the moving direction. Accordingly, the sonar sensor 220 may detect the obstacles in front of the interactive robot 200 (e.g., an obstacle OST1 or an obstacle OST2) along the moving direction of the interactive robot 200. In the activity area F1, when the sonar sensor 220 detects that the distance to the front obstacle OST1 is not less than a distance threshold, the processor 130 may control the interactive robot 200 to continue moving in the moving direction D1. When the sonar sensor 220 detects that the distance to the front obstacle OST1 is less than the distance threshold, the processor 130 may control the interactive robot 200 to adjust the current moving direction D1 to a moving direction D2 (e.g., turning 45 degrees clockwise).

Subsequently, when the sonar sensor 220 detects that the distance to the front obstacle OST2 is not less than the distance threshold, the processor 130 may control the interactive robot 200 to continue moving in the moving direction D2. When the sonar sensor 220 detects that the distance to the front obstacle OST2 is less than the distance threshold, the processor 130 may control the interactive robot 200 to adjust the current moving direction D2 to a moving direction D3 (e.g., turning 45 degrees clockwise). In some embodiments, the distance threshold (e.g., 10 centimeters) may be preset by the user or obtained based on statistics from multiple experiments.

In some embodiments, the display 210 may be implemented by any type of display screen (e.g., a light-emitting diode screen, an organic light-emitting diode screen, a cathode ray tube screen, or the like). In some embodiments, the sonar sensor 220 may be implemented by any type of sonar (e.g., an active sonar, a passive sonar, a reflected sonar, or the like). In some embodiments, the sound playback circuit 230 may be implemented by any speaker for playing sound (e.g., a dynamic speaker, an electrostatic speaker, a dome speaker, or the like).

In some embodiments, the camera circuit 110 and the sound receiving circuit 120 may also be disposed on a surface of the interactive robot 200 facing the moving direction. Accordingly, the camera circuit 110 may capture images toward the moving direction of the interactive robot 200, and the sound receiving circuit 120 may also receive sounds toward the moving direction of the interactive robot 200.

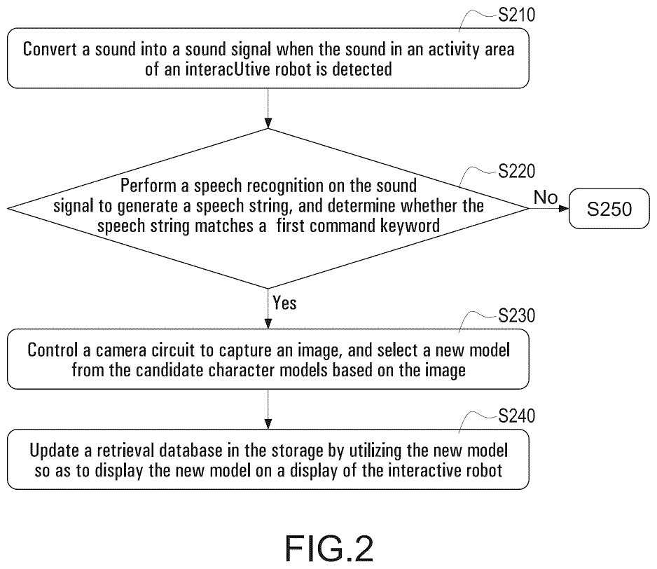

Referring also to FIG. 2, FIG. 2 illustrates a flowchart of a processing method for social interactions with a robot in some embodiments of the present disclosure. The processing method is applicable to the processing apparatus 100 of FIG. 1A. As shown in FIG. 2, first, in step S210, the sound receiving circuit 120 converts a sound into a sound signal when the sound in an activity area F1 of an interactive robot 200 is detected. In other words, whenever the sound receiving circuit 120 detects the sound in the activity area F1, the sound receiving circuit 120 may convert the sound which is detected into the sound signal.

In step S220, a processor 130 performs a speech recognition on the sound signal to generate a speech string, and determines whether the speech string matches a first command keyword. When the processor 130 determines that the speech string matches the first command keyword, the processor 130 performs step S230. Conversely, when the processor 130 determines that the speech string does not match the first command keyword, the processor 130 performs step S250 described in the subsequent paragraphs (to be described later).

In some embodiments, the speech recognition may be implemented by any algorithm for accurately mapping language units in speech (for example, syllables or words) to corresponding text forms (for example, the whisper-small model proposed by OpenAI, the hidden Markov model (HMM), the Gaussian mixture model (GMM), a long short-term memory model (LSTM model), and the like).

In some embodiments, the first command keyword may be related to one of a plurality of keyword types. In some embodiments, the keyword types include types of any objects placed in a general residence (for example, fruits, furniture, plants, and electrical appliances, etc.). For example, when the user wants to set the keyword type related to the first command keyword as fruits, the user may further set the first command keyword as “detect fruits” via the processor 130. When the user wants to set the keyword type related to the first command keyword as electrical appliances, the user may further set the first command keyword as “detect electrical appliances” via the processor 130.

In some embodiments, the processor 130 determines whether the speech string includes the first command keyword. When the speech string includes the first command keyword, the processor 130 determines that the speech string matches the first command keyword. Conversely, when the speech string does not include the first command keyword, the processor 130 determines that the speech string does not match the first command keyword. For example, assuming that the first command keyword is “detect fruits” and the speech string is “I want to detect fruits”, the processor 130 may determine that the speech string includes the first command keyword and determine that the speech string matches the first command keyword.

In step S230, the processor 130 controls a camera circuit 110 to capture an image, and selects a new model from the candidate character models CM1-CMT based on the image, wherein T may be any positive integer. In some embodiments, the image recognition may be implemented by any algorithm (such as a YOLOv8n model, a faster region-based convolutional neural network (faster R-CNN) model, a histogram of oriented gradients (HOG) algorithm, or the like) for recognizing a specific object (that is, an object corresponding to one of the candidate object types described above) from the image.

In some embodiments, the processor 130 performs the image recognition on the image to determine whether an object corresponding to one of the candidate object types is present in the image. When the object corresponding to one of the candidate object types is present in the image, the processor 130 selects, from the candidate character models CM1-CMT, a candidate character model corresponding to the one of the candidate object types as the new model. Conversely, when no object corresponding to one of the candidate object types is present in the image, the processor 130 determines whether the sound receiving circuit 120 generates a new sound signal, and re-performs step S220 when the sound receiving circuit 120 generates the new sound signal.

In some embodiments, the keyword type related to the first command keyword mentioned above indicates a plurality of candidate object types. For example, assuming that the keyword type related to the first command keyword is fruit, the keyword type indicates oranges, guavas, strawberries, and the like. Assuming that the keyword type related to the first command keyword is electrical appliances, the keyword type indicates electric fans, refrigerators, televisions, and the like. In some embodiments, the candidate object types respectively correspond, in a one-to-one manner, to a portion of the candidate character models.

In some embodiments, the candidate character models CM1-CMT include a plurality of common models and a plurality of rare models, wherein a number of the common models is significantly greater than a number of the rare models, and each of the common models and the rare models respectively has a preset character level. In some embodiments, the character levels of the common models and the rare models may also be preset by designers in advance. In some embodiments, the portion (mentioned above) of the candidate character models are all common models and have the lowest character level (for example, all having character level 1).

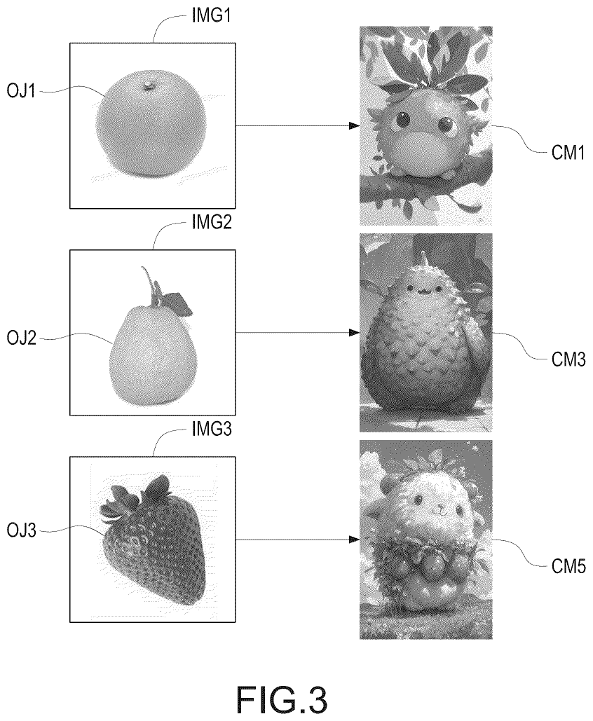

The following describes the generation of a new model by way of an actual example. Referring also to FIG. 3, FIG. 3 illustrates a schematic diagram of a selected candidate character model CM1 in some embodiments of the present disclosure. As shown in FIG. 3, assuming that the keyword type related to the first command keyword is fruit and that the processor 130 recognizes, from an image IMG1, an object OJ1 corresponding to orange among the candidate object types, the processor 130 may select, from the candidate character models CM1-CMT, the candidate character model CM1 corresponding to the orange as the new model, wherein the candidate character model CM1 is a common model and has a character level of 1.

Assuming that the keyword type related to the first command keyword is fruit and that the processor 130 recognizes, from an image IMG2, an object OJ2 corresponding to guava among the candidate object types, the processor 130 may select, from the candidate character models CM1-CMT, the candidate character model CM3 corresponding to the guava as the new model, wherein the candidate character model CM3 is also a common model and has a character level of 1.

Assuming that the keyword type related to the first command keyword is fruit and that the processor 130 recognizes, from an image IMG3, an object OJ3 corresponding to strawberry among the candidate object types, the processor 130 may select, from the candidate character models CM1-CMT, the candidate character model CM5 corresponding to the strawberry as the new model, wherein the candidate character model CM5 is also a common model and has a character level of 1.

Referring back to FIG. 2, in step S240, the processor 130 updates a retrieval database 141 by utilizing the new model so as to display the new model on a display 210 of the interactive robot 200. In other words, the user may view the image of the new model on the display 210 of the interactive robot 200 to learn which new model has currently been obtained. In some embodiments, the processor 130 stores the new model as a new retrieval model in the retrieval database 141. Accordingly, the processor 130 may continuously collect new models using the above method to update the retrieval models OM1-OMS in the retrieval database 141.

Through the above steps, in the present disclosure, the user may issue a sound corresponding to a specific first command keyword to the interactive robot 200 when the interactive robot 200 moves in front of an item corresponding to one of the candidate object types (e.g., an orange). When the processor 130 determines that the user has issued the sound corresponding to the specific first command keyword and that the item has been captured, the processor 130 may obtain the new model corresponding to the item for the user to view. Accordingly, the user may use voice-command statements to have the interactive robot 200 acquire various new models and interact with the interactive robot 200.

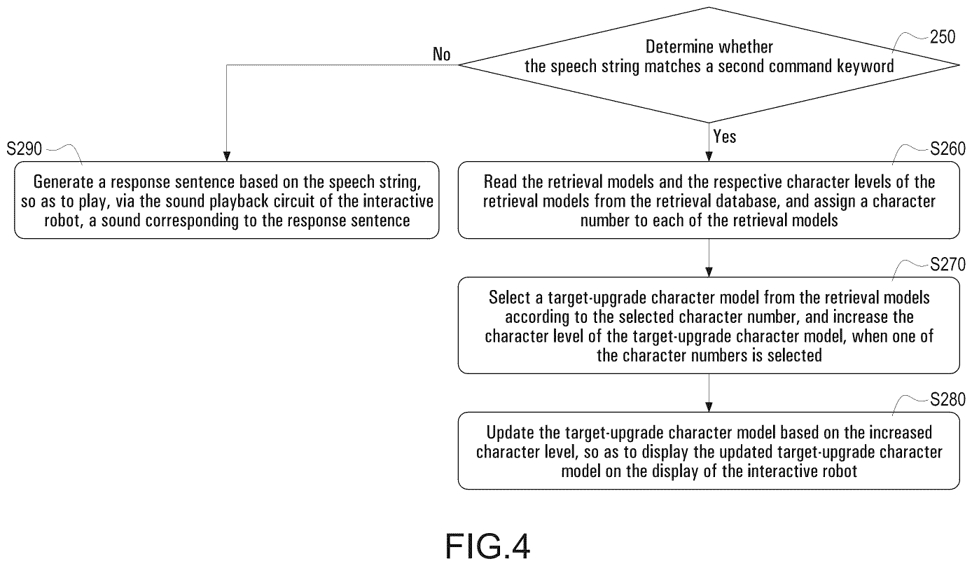

Referring also to FIG. 4, FIG. 4 illustrates a flowchart of multiple steps S250-S290 further included in the processing method for social interactions with a robot in some embodiments of the present disclosure. As shown in FIG. 4, in step S250, the processor 130 determines whether the speech string matches a second command keyword. When the speech string matches the second command keyword, the processor 130 performs step S260. Conversely, when the speech string does not match the second command keyword, the processor 130 performs step S290. In some embodiments, the second command keyword is related to an instruction about upgrading (for example, the second command keyword is “upgrade the character” or “the character wants to upgrade”).

In some embodiments, the processor 130 determines whether the second command keyword is present in the speech string. When the second command keyword is present in the speech string, the processor 130 determines that the speech string matches the second command keyword. Conversely, when the second command keyword is not present in the speech string, the processor 130 determines that the speech string does not match the second command keyword. For example, assuming that the second command keyword is “upgrade the character” and the speech string is “I want to upgrade the character now”, the processor 130 may determine that the second command keyword is present in the speech string and that the speech string matches the second command keyword.

In step S260, the processor 130 reads the retrieval models OM1-OMS and the respective character levels of the retrieval models OM1-OMS from the retrieval database 141, and assigns a character number to each of the retrieval models OM1-OMS. In some embodiments, the processor 130 controls the display 210 of the interactive robot 200 to sequentially display the retrieval models OM1-OMS and the respective character numbers of the retrieval models OM1-OMS, so that the user may view the currently obtained retrieval models OM1-OMS and their respective character numbers. In some embodiments, the processor 130 assigns different character numbers to the retrieval models OM1-OMS in sequence. In some embodiments, the processor 130 may assign the character numbers to the retrieval models OM1-OMS in ascending order (for example, sequentially setting the character numbers of the retrieval models OM1-OMS as 1-S).

In step S270, when one of the character numbers is selected, the processor 130 selects a target-upgrade character model from the retrieval models OM1-OMS according to the selected character number, and increases the character level of the target-upgrade character model. In some embodiments, the sound receiving circuit 120 converts another sound into another sound signal when the another sound in the activity area F1 of the interactive robot 200 is detected. Then, the processor 130 performs the speech recognition on the another sound signal to generate another speech string, and determines whether the another speech string matches one of the character numbers. Subsequently, when the another speech string matches one of the character numbers, the processor 130 selects the retrieval model corresponding to the matched character number as the target-upgrade character model.

In some embodiments, the processor 130 determines whether one of the character numbers is present in the another speech string. When it is determined that one of the character numbers is present in the another speech string, the processor 130 determines that the another speech string matches one of the character numbers. Conversely, when it is determined that none of the character numbers is present in the another speech string, the processor 130 determines that the another speech string does not match any of the character numbers, and performs step S290. For example, assuming that the character number of one of the retrieval models is 5 and the another speech string is “character number 5”, the processor 130 may determine that this character number of the retrieval model is present in the another speech string, and determine that the another speech string matches this character number of the retrieval model.

In step S280, the processor 130 updates the target-upgrade character model based on the increased character level, so as to display the updated target-upgrade character model on the display 210 of the interactive robot 200. In some embodiments, the processor 130 selects, from a plurality of candidate virtual characters, one that corresponds to the target-upgrade character model and the increased character level as the updated target-upgrade character model.

In some embodiments, the candidate character models are divided into a plurality of character groups, each character group including candidate character models having character levels. The processor 130 selects the character group that includes the target-upgrade character model. Next, the processor 130 obtains, from the selected character group, the candidate character model corresponding to the increased character level as the updated target-upgrade character model. In some embodiments, when a candidate character model corresponding to the increased character level cannot be obtained from the selected character group, the processor 130 controls a sound playback circuit 230 of the interactive robot 200 to play a sound corresponding to a prompt statement, wherein the prompt statement indicates that the selected target-upgrade character model cannot be upgraded (e.g., the prompt statement is “the character cannot be upgraded”).

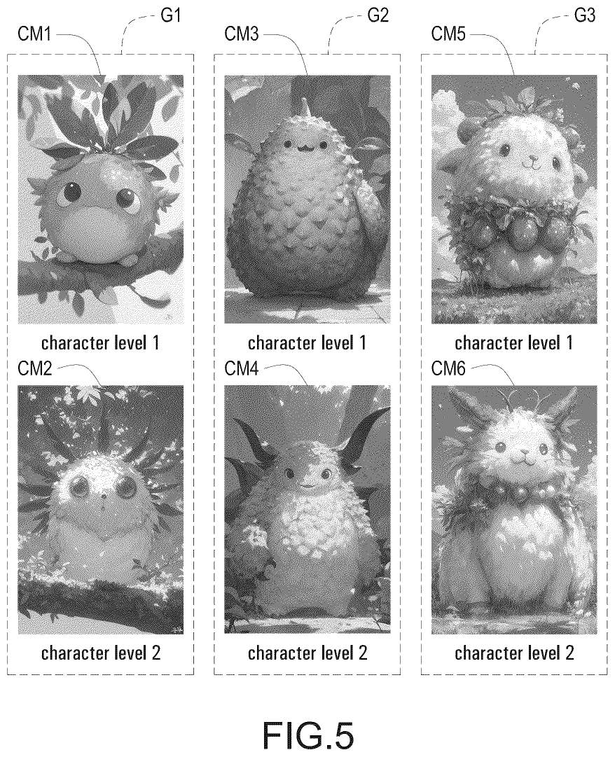

An embodiment of the character groups and the character levels is described below. Referring also to FIG. 5, FIG. 5 illustrates a schematic diagram of a plurality of the character groups G1-G3 in some embodiments of the present disclosure. As shown in FIG. 5, candidate character models CM1-CM6 are used as an embodiment. The candidate character models CM1-CM6 may be divided into three character groups G1-G3, wherein the character group G1 includes the candidate character models CM1-CM2, the character group G2 includes the candidate character models CM3-CM4, and the character group G3 includes the candidate character models CM5-CM6.

In the character group G1, the candidate character models CM1-CM2 have character levels 1-2, respectively. In the character group G2, the candidate character models CM3-CM4 also have character levels 1-2, respectively. In the character group G3, the candidate character models CM5-CM6 also have character levels 1-2, respectively. Assuming that the target-upgrade character model is the candidate character model CM1 with the character level 1, the processor 130 may increase the character level from 1 to 2 and obtain, from the character group G1, the candidate character model CM2 corresponding to the character level 2 as the updated target-upgrade character model.

Further, assuming that the target-upgrade character model is the candidate character model CM5 with the character level 1, the processor 130 may increase the character level from 1 to 2 and obtain, from the character group G3, the candidate character model CM6 corresponding to the character level 2 as the updated target-upgrade character model. It is noted that, although three character groups each including two candidate character models are used as an embodiment here, in practical applications, a character group may include more candidate character models, and all candidate character models may be divided into a greater number of character groups.

In step S290, the processor 130 generates a response sentence based on the speech string, so as to play, via the sound playback circuit 230 of the interactive robot 200, a sound corresponding to the response sentence. In some embodiments, the processor 130 generates the response sentence corresponding to the speech string by utilizing a language model processing. In other words, when the user simply wants to chat (i.e., the speech string does not match the first command keyword or the second command keyword), the processor 130 may generate the response sentence corresponding to the speech string converted from the user's voice by utilizing the language model processing, and control the sound playback circuit 230 to play the sound corresponding to the response sentence for the user to listen to, thereby enabling chat interaction. In some embodiments, the language model processing may be implemented using any large language model for conversation (e.g., the generative pre-trained transformers (GPT) model, the bidirectional encoder representations from transformers (BERT), or the text-to-text transfer transformer (T5) model).

Through the above steps, the present disclosure may, when determining that the speech string matches the second command keyword, increase the character level of one of the retrieval models based on the character number corresponding to the user's subsequently issued voice, and display, on the display 210, an image of the retrieval model with the increased character level for the user to view. In addition, when the user simply wants to chat, the present disclosure further generates a response sentence using the language model processing and plays, via the sound playback circuit 230, the sound corresponding to the response sentence for the user to listen to.

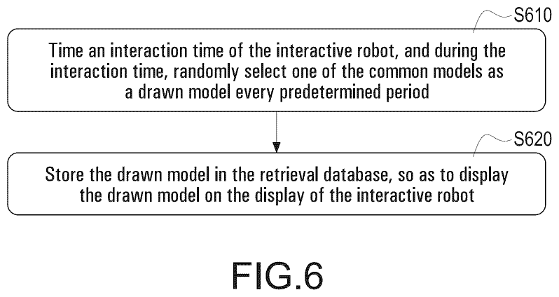

Referring also to FIG. 6, FIG. 6 illustrates a flowchart of a processing method for social interactions with a robot further including a plurality of steps S610-S620 according to other embodiments of the present disclosure. As shown in FIG. 6, in step S610, the processor 130 times an interaction time of the interactive robot 200, and during the interaction time, randomly selects one of the common models as a drawn model every predetermined period. In step S620, the processor 130 stores the drawn model in the retrieval database 141, so as to display the drawn model on the display 210 of the interactive robot 200.

In other words, every predetermined period, the processor 130 employs a card-drawing mechanism to randomly select one of all the common models among the candidate character models CM1-CMT as the drawn model to store in the retrieval database 141 (i.e., the drawn model is stored as a new retrieval model). The user may view on the display 210 of the interactive robot 200 that a common model is obtained by the interactive robot 200 every time this predetermined period elapses. In some embodiments, the interaction time is the time elapsed after the interactive robot 200 is powered on. In some embodiments, the predetermined period may be set in advance by the user (e.g., 1 minute).

In some embodiments, the processor 130 further, during the interaction time, randomly selects one of the rare models as another drawn model every another predetermined period that is greater than the predetermined period. Then, the processor 130 stores the another drawn model in the retrieval database 141, so as to display the another drawn model on the display 210 of the interactive robot 200.

In other words, every another predetermined period that is greater than the predetermined period, the processor 130 also employs a card-drawing mechanism to randomly select one of all the rare models from the candidate character models CM1-CMT as the another drawn model, and stores it in the retrieval database 141 (i.e., this another drawn model is also treated as a new retrieval model). The user may view on the display 210 of the interactive robot 200 that a rare model is obtained by the interactive robot 200 each time this another predetermined period elapses. In some embodiments, this another predetermined period may also be preset by the user (e.g., 5 minutes).

In some embodiments, during the interaction time, the processor 130 further stores an upgrade card model in the retrieval database 141 every still another predetermined period that is less than the predetermined period, so as to display the upgrade card model on the display 210 of the interactive robot 200, wherein the upgrade card model is used to increase the character level of one of the retrieval models in the retrieval database 141. In some embodiments, the upgrade card model is a two-dimensional or three-dimensional model of a virtual card indicating the upgrade of one of the retrieval models (e.g., a two-dimensional card model with the string “Upgrade”).

In other words, every still another predetermined period that is less than the predetermined period, the processor 130 stores an upgrade card model in the retrieval database 141. The user may view on the display 210 of the interactive robot 200 that an upgrade card model is obtained by the interactive robot 200 each time this still another predetermined period elapses. In some embodiments, this still another predetermined period may also be preset by the user (e.g., 30 seconds).

In some embodiments, when the processor 130 determines that the above-mentioned speech string matches the second command keyword, the processor 130 may further determine whether an upgrade card model is present in the retrieval database 141. When an upgrade card model is present in the retrieval database 141, the processor 130 proceeds to perform the above steps S260-S280. Conversely, when no upgrade card model is present in the retrieval database 141, the processor 130 controls the sound playback circuit 230 of the interactive robot 200 to play a sound corresponding to another prompt statement, wherein the another prompt statement indicates that no upgrade card has been obtained (e.g., the another prompt statement is “No upgrade card”).

By the above steps, the present disclosure may continuously obtain the common models, the rare models, or the upgrade card models, and display these models on the display 210 of the interactive robot 200 for the user to view. Accordingly, the user may interact with the interactive robot 200 both visually and through dialogue based on the user's own needs and the viewed images.

In summary, the processing method and apparatus for social interactions with a robot provided by the present disclosure may perform the speech recognition on sounds uttered by the user to determine what command the user intends to issue to the interactive robot. When the user observes that the interactive robot has moved near a specific object, the user may issue a command to the interactive robot to recognize this object. The processing method and apparatus disclosed herein then display, on the display of the interactive robot, a virtual character corresponding to the object for the user to view. Accordingly, the processing method and apparatus disclosed herein allows the interactive robot, which is a general household interactive robot, to interact with the user both through dialogue and visually, thereby enhancing the social interactions of the interactive robot and improving the user's psychological state through such social interactions. Furthermore, when the user intends to upgrade the appearance of a virtual character, the user may issue a command to perform the upgrade along with the character number of the target-upgrade character to the interactive robot. The processing method and apparatus disclosed herein then display, on the display of the interactive robot, the upgraded virtual character according to the command and the character number for the user to view. Accordingly, the processing method and apparatus disclosed herein further allows the user to interact with the virtual character. On the other hand, the processing method and apparatus disclosed herein may also engage in conversational interaction with the user even in the absence of user-issued commands. In this way, the processing method and apparatus disclosed herein significantly enhance the level of communication with the user.

Although the present disclosure has been described above with reference to embodiments, it is not intended to limit the present disclosure. Those having ordinary skill in the art may make various modifications and variations without departing from the spirit and scope of the present disclosure. Therefore, the scope of the present disclosure should be defined by the appended claims.

What is claimed is:

1. A processing method for social interactions with a robot, applicable to an interactive robot, comprising:
step a) converting a sound into a sound signal via a sound receiving circuit when the sound in an activity area of the interactive robot is detected;
step b) performing a speech recognition on the sound signal via a processor to generate a speech string, and determining whether the speech string matches a first command keyword;
step c) when the speech string matches the first command keyword, controlling a camera circuit via the processor to capture an image, and selecting a new model from a plurality of candidate character models stored in a storage based on the image; and
step d) updating a retrieval database stored in the storage using the new model via the processor, so as to display the new model on a display of the interactive robot.

2. The processing method according to claim 1, wherein the step c) comprises:
performing an image recognition on the image to determine whether an object corresponding to one of a plurality of candidate object types is present in the image; and
when the object corresponding to the one of the candidate object types is present in the image, selecting, via the processor, the candidate character model corresponding to the one candidate object type from the candidate character models as the new model.

3. The processing method according to claim 1, further comprising:
step e) determining, via the processor, whether the speech string matches a second command keyword;
step f) when the speech string matches the second command keyword, reading, via the processor, a plurality of retrieval models and a character level of each of the retrieval models from the retrieval database, and assigning a character number to each of the retrieval models;
step g) when one of the character numbers is selected, selecting, via the processor, a target-upgrade character model from the retrieval models according to the character number which is selected, and increasing the character level of the target-upgrade character model;
step h) updating, via the processor, the target-upgrade character model based on the character level which is increased, so as to display the target-upgrade character model which is updated on the display of the interactive robot.

4. The processing method according to claim 3, wherein the step g) comprises:
converting another sound into another sound signal via the sound receiving circuit when the another sound in the activity area of the interactive robot is detected;
performing, via the processor, the speech recognition on the another sound signal to generate another speech string, and determining whether the another speech string matches one of the character numbers; and
when the another speech string matches one of the character numbers, selecting, via the processor, the retrieval model corresponding to the character number which is matched as the target-upgrade character model.

5. The processing method according to claim 3, wherein the step h) comprises:
step h1) selecting, via the processor, one of the candidate characters that corresponds to the target-upgrade character model and the character level which is increased as the target-upgrade character model which is updated.

6. The processing method according to claim 5, wherein the candidate character models are divided into a plurality of character groups, each of the candidate character models in the character groups having the character level, and wherein the step h1) comprises:
selecting, via the processor, the character group which includes the target-upgrade character model; and
obtaining, via the processor, from the character group which is selected, the candidate character model corresponding to the character level which is increased as the target-upgrade character model which is updated.

7. The processing method according to claim 1, wherein the candidate character models include a plurality of common models and a plurality of rare models, a number of the common models being significantly greater than a number of the rare models, and wherein the processing method further comprises:
timing, via the processor, an interaction time of the interactive robot, and during the interaction time, randomly selecting one of the common models as a drawn model every predetermined period; and
storing, via the processor, the drawn model in the retrieval database so as to display the drawn model on the display of the interactive robot.

8. The processing method according to claim 7, further comprising:
randomly selecting, via the processor, one of the rare models as another drawn model every another predetermined period during the interaction time, the another predetermined period being greater than the predetermined period; and
storing, via the processor, the another drawn model in the retrieval database so as to display the another drawn model on the display of the interactive robot.

9. The processing method according to claim 7, further comprising:
storing, via the processor, an upgrade card model in the retrieval database every another predetermined period during the interaction time, the another predetermined period being less than the predetermined period, so as to display the upgrade card model on the display of the interactive robot, wherein the upgrade card model is used to increase a character level of one of a plurality of retrieval models in the retrieval database.

10. A processing apparatus for robot interactions, disposed in an interactive robot, comprising:
a camera circuit, configured to capture an image;
a sound receiving circuit, configured to convert a sound into a sound signal when the sound in an activity area of the interactive robot is detected;
a storage, configured to store a retrieval database, a plurality of candidate character models, and a plurality of commands; and
a processor, connected to the camera circuit, the sound receiving circuit, and the storage, and accessing the commands to perform the following actions:
action a) performing a speech recognition on the sound signal to generate a speech string, and determining whether the speech string matches a first command keyword;
action b) when the speech string matches the first command keyword, controlling the camera circuit to capture the image, and selecting a new model from the candidate character models based on the image; and
action c) updating the retrieval database by utilizing the new model, so as to display the new model on a display of the interactive robot.
